(19) United States
(12) Patent Application Publication
(10) Pub. No.: US 2012/0240650 A1
(43) Pub. Date: Sep. 27, 2012

(54) STABILIZATION AND REMOTE RECOVERY OF ACID GAS FRACTIONS FROM SOUR WELLSITE GAS

(75) Inventors: Satish Iyer, Calgary (CA); Richard Knoll, Calgary (CA)

(73) Assignee: SULVARIS INC., Calgary, AB (CA)

(21) Appl. No.: 13/501,958

(22) PCT Filed: Oct. 21, 2010
(86) PCT No.: PCT/CA2010/001669

§ 371 Date: Jun. 8, 2012

(30) Foreign Application Priority Data
Oct. 21, 2009 (CA) 2,683,983

(51) Int. Cl. B01D 53/14; C05D 9/00; B01D 19/00

(52) U.S. Cl. 71/31; 95/156; 95/186; 95/158

(57) ABSTRACT

A method for the recovery of hydrogen sulphide and other acid gas fractions from sour wellsite gas in hydrocarbon production is provided. The selected acid gas fractions are absorbed into a noncorrosive and transportable solvent solution at the wellsite, the rich solvent solution being transported to a central plant location where it is desorbed from the solvent solution for further handling or processing. The lean solvent solution can then be recycled. Multiple acid gas fractions could be recovered from the sour gas in question using a single appropriate solvent solution. Carbon dioxide could be absorbed and desorbed at the wellsite rather than at the central plant location. Clean gas is yielded at the natural gas into solvent wellsite for downstream processing or sale.

This invention is in the field of hydrocarbon recovery and processing, and more specifically deals with a method for the safe and economical recovery of hydrogen sulphide and other acid gas fractions from wellsite gas.

### BACKGROUND

Natural gas streams produced from some subterranean formations contain substantial volumes of various acid gas fractions such as hydrogen sulphide (H₂S), carbon dioxide (CO₂) and the like. These natural gas streams, referred to as “sour gas” at the wellsite, must be purified and the acid gas fractions removed before being sent to market. The process of removal of these acid gas fractions is referred to in the industry as “sweetening” the sour wellsite natural gas stream.

There are various methods for the sweetening of natural gas streams to remove acid gas fractions therefrom. One of the most basic methods for sweetening a natural gas stream in the past has been to recover those acid gas fractions from the natural gas stream and to simply flare them off at the wellsite, re-inject them back into the ground, such as in a dead well or an underground cavern, or to process them in a plant to produce elemental sulphur. Beyond the costs associated with this type of method, there are negative environmental impact on a number of levels. In addition, flaring at the wellsite has another significant economic disadvantage namely that the actual acid component of the sour gas insofar as it is flared off or disposed is not in any way used as a positive revenue source. In addition, elemental sulphur is very low market value and with increasing sulphur production around the world the production of elemental sulphur from sour gas is at best only a minor revenue source.

The safe handling of sour gas and the removal of acid gas fractions therefrom is a significant economic factor in the feasibility of certain hydrocarbon recovery projects. In cases where it has been desired in the past to remove hydrogen sulphide and other acid gas fractions from a natural gas stream for example, solvent absorption methods have been practiced in the past whereby the gas stream from the wellsite is conveyed to a central processing facility where the hydrogen sulphide or other identified non-desirable acid gas fractions removed by solvent absorption or other similar techniques. The physical plant costs of these types of recovery methods is astronomical however, since in that circumstance it is necessary to pipe the gas stream, containing the acid gas fractions, to the central processing location and the pipeline which needs to be built must be resistant to acid gas corrosion. High cost materials must be used, and even this is not a full insurance against corrosion related failures which almost always result in fatalities or severe health disabilities in humans and livestock apart from the damage to flora and fauna. Hence expensive pipeline inspection and monitoring services are required to be performed periodically on an ongoing basis. Once a particular well is retired, that pipeline becomes redundant or useless and needs to be abandoned, which is a particular economic concern.

An alternative which has also been tried in the past, in the place of piping the hydrocarbon stream to a central processing location for recovery or removal of the acid gas fractions there from has been to endeavor to develop on-site acid recovery equipment. Again, the plant costs of installing acid recovery equipment such as this can be staggering on an individual unit basis, and as a producer with hundreds of wells, if acid extraction equipment such as this were required at each wellsite the infrastructure cost of distributed acid recovery on this basis becomes impractical.

Purification or cleaning of sour gas to recover acid gas fractions therefrom, in addition to a major economic consideration in certain oil and gas projects, can also pose a significant safety and environmental concern if inappropriately handled or the recovery process or equipment is breached. In the case for example of piping of the virgin natural gas streams to a central processing location for the removal of acid gas fractions therefrom, if there is a breach in the piping, could cause major damage to life and property. In addition to the problem of the actual environmental release of such acid gas fractions, there is also the human risk and safety factor associated with maintaining these pipelines and minimizing or avoiding the risk of pipe breaches. Gas releases from such pipeline breaches cannot be controlled or contained in any manner whatsoever and they are left to the mercy of natural wind and air convection currents to disperse them down to low levels of concentration.

### SUMMARY OF THE INVENTION

In one aspect, a method for acid recovery from natural gas obtained at a wellsite is provided. The method comprises: absorbing at the wellsite at least one acid gas fraction from the natural gas into a solvent to form a sweetened natural gas and a rich solvent containing the at least one acid gas fraction and; transporting the rich solvent to a remote treatment site; and desorbing at the remote treatment site the at least one acid gas fraction from the rich solvent resulting in an acid gas and a lean solvent.

In another aspect, a method for acid recovery from natural gas obtained at a wellsite is provided. The method comprises: preconditioning the natural gas at the wellsite to remove condensates from the natural gas, the condensates comprising water; absorbing at the wellsite at least one selected acid gas fraction, the acid gas fraction comprising at least hydrogen sulphide, from the natural gas into a solvent to form a sweetened natural gas and a rich solvent containing the at least one acid gas fraction; transporting the rich solvent to a remote treatment site; transporting the sweetened natural gas to a location other than the remote treatment site; desorbing at the remote treatment site the at least one acid gas fraction from the rich solvent resulting in an acid gas and a lean solvent; and transporting the lean solvent, created from desorbing the rich solvent, back to the wellsite and using the lean solvent to absorb an other at least one acid gas fraction from natural gas obtained at the wellsite.

In one variation on the method of the present invention, there is contemplated the local sequestration of some acid gas fractions and then the transport for remote recovery of others by their absorption into a rich solvent. It is specifically contemplated that for example following the absorption of hydrogen sulfide or other acid gas fractions which was desired to remove from the sour natural gas, the lean solvent which was obtained from the removal of those acid gas fractions from the rich solvent at the remote central plant location could be recycled for use in a secondary absorption step back at the wellsite where carbon dioxide could be absorbed, and then immediately desorbed right there at the well site for disposal or further processing. Removal of carbon dioxide at the well site rather than transporting rich solvent containing large quantities of carbon dioxide is desirable simply because of the volume of carbon dioxide which typically needs to be scrubbed from the sour gas.

### DESCRIPTION OF DRAWINGS

Preferred embodiments are provided in the accompanying detailed description which may be best understood in conjunction with the accompanying diagrams where like parts in each of the several diagrams are labeled with like numbers, and where:

FIG. 1 is a flow chart demonstrating the schematic steps of one basic embodiment of the method of the present invention;

FIG. 2 is a schematic of one embodiment of the portable wellsite capture apparatus of the present invention, showing a single solvent absorption unit;

FIG. 3 is a schematic of one embodiment of an acid recovery apparatus of the present invention, showing two acid recovery units;

FIG. 4 is a schematic diagram of one embodiment of a system in accordance with the present invention, showing a single well site capture device and a single acid recovery station, with the rich solvent being transported between those two locations by truck;

FIG. 5 is a schematic diagram of one embodiment of the system in accordance with the present invention showing for wellsite capture devices and the single acid recovery station, with the rich solvent being demonstrated being transported between these locations both by truck as well as by pipeline. Recycled lean solvent is also piped back to the wellsite locations from the central plant;

FIG. 6 is a schematic diagram of one embodiment of an acid recovery apparatus in accordance with the present invention;

FIG. 7 is a flow chart demonstrating the schematic steps of an alternate embodiment of the method of the present invention which includes a secondary absorption step at the wellsite to absorb and been desorbed on site at the wellsite carbon dioxide.

### DETAILED DESCRIPTION OF ILLUSTRATED EMBODIMENTS

As outlined in further detail above, it is the object of the present invention to provide an improved method and apparatus for the stable recovery of acid gas fractions from a wellsite gas stream, removing or minimizing the need for acid gas discharge from well site to a centralized recovery facility.

Dependent upon the particular subterranean foundation in question there may be different acid gas fractions present within a natural gas stream which may need to be removed to yield clean natural gas for sale. Two of the primary acid gas fractions which are particularly plentiful and problematic are carbon dioxide and hydrogen sulphide. Not only is hydrogen sulphide one of the primary problematic acid gas fractions to be extracted from sour wellsite gas streams, but the hydrogen sulphide which is recovered can be further processed to obtain sulphuric acid, for resale or use in commercial applications. However, there are other acid gas fractions which could also be targeted using the methods disclosed herein. For example, either in addition to hydrogen sulphide or as the primary and only target, carbon dioxide could be recovered from a sour wellsite gas stream, for the purpose of purification of the gas stream for downstream sale or further processing.

In certain cases there may be other acid gas fractions within the natural gas as well which it was desired to recover either for the purposes of purification or for further economic benefit or use. Different acid gas fractions of a natural gas stream could be targeted using the methods described herein either by changing or adjusting the solvent which was being used to absorb the acid gas fraction at the wellsite for remote or off-site processing, or in certain circumstances the same solvent might be used but there might be the need for process parameter adjustments to optimize the absorption of a different acid gas fraction.

In certain cases, if the appropriate solvent were used, the methods described herein could actually be used to recover more than one acid gas fraction from the sour gas stream, and that the multiple acid gas fractions could be separately desorbed from the solvent.

Various solvents could be used in the methods disclosed herein. The key qualities of the solvent used would be that the solvent, when enriched with hydrogen sulphide or other acid gas fractions absorbed therein, would be a non-corrosive liquid which could be transported in a stable and safe manner.

Depending upon the chemical profile at the acid gas fraction which it was desired to remove from a natural gas stream, there may be a single chemical agent which could be used as a fluid solvent to absorb that acid gas fraction, or, and as is more likely the case, it may actually be a blend of more than one chemical agents. While this document refers to “solvent” in the singular context, the possibility and in fact the probability of the solvent actually being a multiple chemical cocktail rather than a single chemical is explicitly contemplated to be encompassed within that singular reference.

The choice of solvents used would to a degree dictate the type of equipment implemented at the central plant location—for example based upon the type of process which was necessary to be used to desorb the acid gas fraction or fractions from the rich solvent, different types of processing equipment may be required.

Where we speak of the absorbed acid gas fractions in the context of the rich solvent, it will be understood that those acid gas fractions will likely have undergone a phase change and will in fact not be gaseous but rather liquid within the solvent—simply for the sake of clarity and streamlining our language in this document will be understood where we refer to the acid gas fractions as they have been absorbed into the solvent, in the rich solvent state, that the acid gas reference refers to the component of the rich solvent which when desorbed there from will revert to its gaseous acid phase.

The absorption and desorption approach to a particular natural gas source would depend upon the composition of the sour well gas or the natural gas source, as well as the pressure and temperature of that gas source. Another factor which could also be in the mix in terms of determining the nature of the process which would be undertaken or the selection of the lean solvent which would be employed would be the purity of the separation which was required. One or more of the following currently available solvents could be used in the development and practice of the methods described herein:
Any primary, secondary or tertiary amine like, MEA (Mono Ethanol Amine), Di Ethanol Amine, Di Isopropyl Amine, Di Glycol Amine, MDEA (Methy Di Ethanol Amine)
Morphysorb™ (Krupp-Uhde Process)
Genosorb™ (Krupp-Uhde Process)
Selexol™ (UOP Process)
Sulfinol™ (Shell Process)
Rectisol™ (Methanol based Lurgi Process)
Purisol™ (NMP based Lurgi Process)

It will be understood that this grouping of solvent options is only demonstrative of the types of lean solvents, or solvent components, which could be selected or considered for use in terms of the particular acid gas fractions which were desired to be extracted etc. Inclusion of this demonstrative list of solvent possibilities is not intended to be limiting upon the scope of the present invention outlined herein.

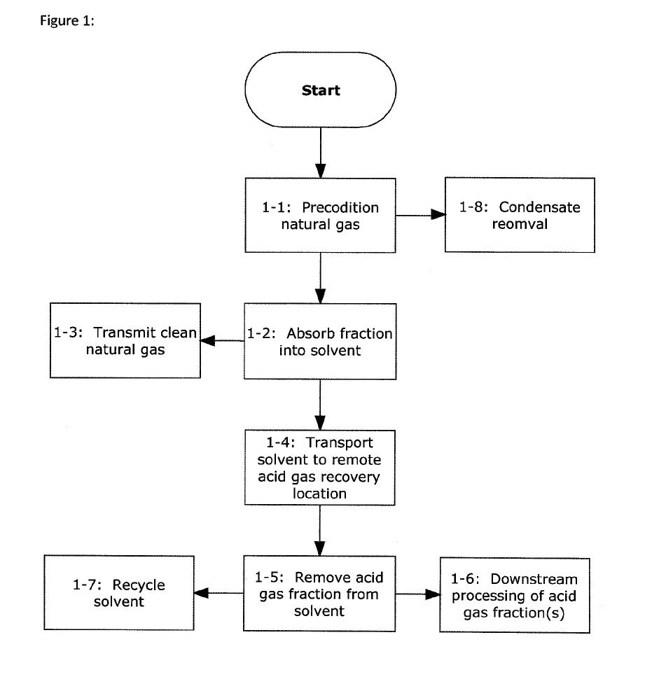

FIG. 1 is a flowchart of a method in one aspect of for recovery of an acid gas fraction from a natural gas stream obtained at a wellsite. In the method, acid gas fractions are absorbed into an appropriate solvent at the wellsite to form a rich solvent containing the absorbed desired acid gas fractions. The rich solvent is transportable, noncorrosive and stable so that the acid gas fraction will substantially remain in the solvent and most if not substantially all of it will not return to its gaseous phase and separate out of the solvent. The rich solvent can then be transported to a central plant at a remote treatment site at which the acid fractions will be desorbed or removed from the solvent for further processing or disposal, and the solvent at that point, being lean and having had the acid fractions removed there from can be recycled for reuse at the wellsite.

The first step in the method is to precondition the natural gas to remove the first series of condensates from the natural gas either for the purpose of cleaning the gas or for the purpose of the economic recovery of those condensates. For example in traditional or conventional natural gas sweetening applications, the preconditioning of natural gas will yield potentially water from the subterranean formation which can be disposed or pumped back down a well, as well as a hydrocarbon condensate which is economically viable and separately salable, and results in a cleaner natural gas stream for the next steps in the process. Referring to FIG. 1, the preconditioning of the natural gas stream is shown at step 1-1. Conventional preconditioning methods for natural gas sweetening can be used. Also shown at block 1-8 in this Figure is the actual removal of the condensate recovered from the preconditioning process.

Once the natural gas stream, which it is desired to recover the acid gas fractions from, has been preconditioned to remove condensates, the next step which will be undertaken is the absorption of the selected acid gas fraction or fractions into the solvent. The absorption step is shown at 1-2. The absorption step would be carried out using a wellsite absorption apparatus as is described elsewhere herein—the selected acid gas fraction or fractions would be absorbed into the solvent bypassing the natural gas stream through the solvent under a predetermined set of parameters.

The key aspect of this step of the present invention is to understand the qualities of the solvent which will be used. Specifically, the solvent which will be selected will depend upon the specific acid gas fraction or fractions which are desired to be removed from the natural gas stream since certain solvents will beneficially absorb certain gases but not others. The specific process steps involved in this acid absorption step will depend upon the gas stream, the acid gas fraction in question as well as the solvent insofar as certain solvents will have varying process requirements to accomplish the absorption of the desired acid gas fractions into the solvent. The necessary equipment will be provided at the wellsite or at the natural gas stream to accomplish the objective of connection of the solvent absorption equipment to the natural gas stream and perform the necessary process steps to yield the transformation of the bare or lean solvent [being the solvent in its clean form not having absorbed the desired acid gas fractions], to a rich solvent into which the desired acid gas fractions have been absorbed. For example where the acid gas fraction which is desired to be removed is hydrogen sulphide, a solvent could be used to selectively absorb pure hydrogen sulphide from a hydrocarbon sour gas stream to yield a benign liquid form rich solvent which can be safely transported and is noncorrosive.

Following the passage of the natural gas through the solvent, at the absorption step, will be “clean”. The transmission of the clean gas from the wellsite is shown in this case at step 1-3. It will also be understood that the transmission of the clean glass could logically be understood to take place at the end of this block diagram but that one where the other following the absorption of the selected acid gas fraction or fractions from the natural gas in question, clean gas will be available for transmission to the sale grid.

The clean gas transmission step would potentially include treating the clean natural gas devoid of the selected acid gas fractions for moisture removal in advance of its conveyance for sales into the clean gas pipeline grid which is typically available at close proximity to the well site.

At step 1-4 the rich solvent, containing the selected absorbed acid gas fractions, can be transported to a central plant at a remote treatment site for further treatment. At the central plant location, the acid gas fractions will be desorbed from the rich solvent, shown at 1-5, to yield lean solvent which can be recycled back in the process, shown at step 1-7, and the desorption of the acid fractions from the rich solvent 9 will result in the availability of relatively pure acid gas which can be processed or otherwise disposed of further, shown at step 1-6. In the example of the selected acid gas fraction being extracted from the natural gas and hydrogen sulphide, the recovered acid gas fraction which will be desorbed from the solvent can be substantially hydrogen sulphide which could be processed further into sulphuric acid or for other purposes. The specific mechanics of recovery of those acid gas fractions from the rich solvent, and the necessary equipment to accomplish this, will depend upon the solvent which is being used as well as the behavior of the acid gas fraction or fractions in question—this step in the process will need to be tailored to include the necessary specific process steps to liberate the acid gas fraction or fractions in question from the solvent, yielding a pure acid gas fraction and a lean solvent, the lean solvent being the solvent with the absorbed acid gas fractions having been removed there from. The lean solvent, being the one result of this process step, can then be recycled back to one or more wellsite absorption locations for reuse in the method of the present invention, and the liberated pure acid gas fractions can be further processed or disposed at the central plant location. The ability to recycle the solvent which is chosen, yielding zero or minimal solvent discharge from the method of the present invention is one significant benefit both in terms of environmental impact as well as cost of the process, since by recycling the solvent not only is it possible to minimize the ongoing purchase amount but also to minimize environmental impact by the discharge of even relatively inert spent solvents.

By recovering one or more selected acid gas fractions from the sour natural gas at the wellsite, the remaining sweet gas at the wellsite following absorption of the acid gas fractions there from can be immediately forwarded on for sale or further processing. Absorption of the acid gas fraction or fractions into a solvent for remote acid recovery also reduces the amount of equipment required at the wellsite to remove these acid gas fractions and as such will be economically beneficial to well operators. Even in circumstances where the wellsite location was not connected to any kind of a pipeline for transport of the rich solvent and the rich solvent was stored in a tank or the like pending transport by truck or otherwise to the central plant location, the noncorrosive and safe nature of the rich solvent will mean that even the storage equipment such as tanks and the like can be manufactured of regular materials rather than the need to use higher cost and noncorrosive materials.

As will be specifically outlined in more detail below, it is contemplated that the equipment which would be used at the wellsite to absorb the selected acid gas fractions into the selected solvent for transport to the central plant location could be containerized or could otherwise be rendered relatively portable so that it could be moved from location to location as certain wells were either retired or even shut down on a periodic basis, so that the equipment utilization by the operator could be maximized and even the waste of consumable or equipment and materials at wellsites would be minimized such that upon closure of a welder would not be such a significant sunken cost in wasted materials or equipment abandoned that the wellsite or otherwise no longer of use. Similarly in certain circumstances it is contemplated that even the central plant location equipment could be rendered portable so that the central plant location could be moved or beneficially located in relation to a plurality of wellsites within a proximal drilling area. The central plant location could also of course be a permanent installation, and this would just require some modification to the length of transportation required to transport the rich solvent for processing into extract of acid gas fractions and lean solvent which could then be recycled back to the wellsite.

The first step in the method shown in FIG. 1 is the preconditioning of the natural gas stream. As outlined, preconditioning the natural gas in a conventional context consists of removing certain condensates from the gas before it's further processing. For example, water might be removed as natural gas coming from a certain type of a subterranean formation would be more heavily laden with water. The water typically is either disposed or pumped back down an empty well. In any event it needs to be removed before the natural gas can be further processed and transmitted. In addition to the removal of water the other type of condensate which may be desired to remove during the preconditioning step would be hydrocarbon condensate. The hydrocarbon condensate actually can have many types of specific hydrocarbon contents including gasoline etc., and the hydrocarbon condensate which is removed during traditional natural gas sweetening processes commands a strong economic value. On that basis as well as for the fact of rendering or yielding clean natural gas, the preconditioning step would be undertaken in advance of the absorption of the selected acid gas fractions out of the natural gas into the solvent cocktail.

Insofar as preconditioning of natural gas is a conventional process step known in the art it will be understood to those skilled in the art the different types of preconditioning techniques and apparatus which could be used.

A portable wellsite capture apparatus can be used to capture and absorb the acid gas fraction in the solvent. The portable wellsite capture apparatus can be operably connected to a natural gas stream at the wellsite as well as to a source of a selected lean solvent into which one or more selected acid gas fractions can be absorbed. In addition to the operable connections to the natural gas stream and the source of the selected lean solvent, the wellsite capture apparatus would include at least one solvent absorption unit, comprising the equipment necessary to effect the absorption of the selected acid gas fraction or fractions into the selected lean solvent. Specific equipment which would comprise the at least one solvent absorption unit would vary dependent upon the selection of the lean solvent, the acid gas fraction or fractions which were desired to be absorbed, and the necessary process or parameters which would be required in order to effect that absorption. The final component of the wellsite capture apparatus, in addition to the gas source interface, lean solvent source interface and solvent absorption unit or units would be a rich solvent discharge interface. The rich solvent discharge interface would either be a connection to a tank or other storage vessel, or a pipeline or the like, through which the rich solvent containing the absorbed acid gas fraction or fractions could be stored or transported for eventual downstream processing at the central plant location.

The selected solvent source could be integral with the remainder of the wellsite capture apparatus such as a tank or the like, or it could be a pipeline connected to a remote source of the selected solvent.

The portable wellsite capture apparatus might also optionally include the necessary equipment for the preconditioning of the natural gas stream. The preconditioning equipment could be incorporated into the wellsite capture apparatus, or insofar as conventional or prior art preconditioning methods are contemplated or might be used the preconditioning equipment could also be separate and the natural gas stream could basically be preconditioned in advance of its entry into the portable wellsite capture apparatus.

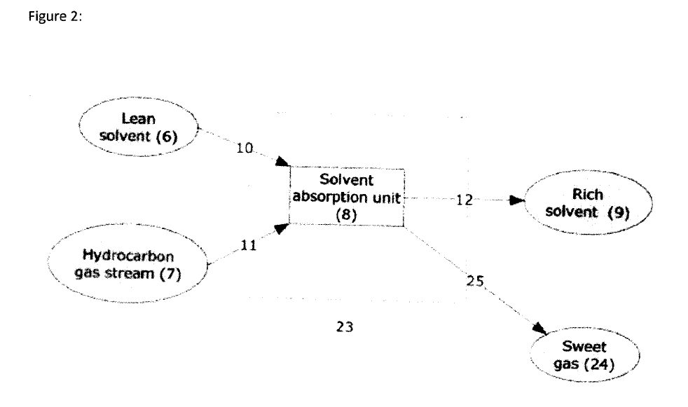

For the sake of demonstration of the general concept of the portable wellsite capture apparatus of the present invention we refer to FIG. 2. The portable wellsite capture apparatus 23 would include at least one solvent absorption unit 8 which would comprise the necessary equipment to effectively absorb one or more selected acid gas fractions from a natural gas stream into a solvent. The solvent absorption unit 8 might comprise one or more actual physical pieces of equipment regardless of the number of acid gas fractions which were desired to be absorbed into the solvent in question. It may also be the case that if more than one acid gas fraction were desired to be absorbed from the natural gas source that more than one type of process would need to be employed to absorb the respective acid gas fractions into the lean solvent in question and on that basis it may be the case that if more than one acid gas fraction were contemplated to be absorbed into the lean solvent in question, more than one solvent absorption unit 8 may be required.

The at least one solvent absorption 8 would be connected to a natural gas stream 7 by a natural gas stream interface 11. The natural gas stream interface 11 may be simply a connection directly to the sour gas stream at the wellsite, or there may be additional preconditioning taking place of the sour gas in advance of its introduction into the apparatus 23. In any event, a natural gas stream interface 11 would be the source of sour gas from which it was desired to remove or absorbed the one or more selected acid gas fractions. As outlined, it is likely that the sour natural gas which was interfaced to the apparatus at 11 would be preconditioned to remove certain condensates in advance of the acid gas fraction absorption step.

In addition to the natural gas stream interface 11, the at least one solvent absorption unit 8 would be connected to a source of a lean solvent 6. The lean solvent would be a solvent which was capable upon the application of certain process parameters in contact with the natural gas stream 7 to result in the absorption of one or more selected acid gas fractions from the natural gas stream 7. The lean solvent source 6 might be a tank, pipeline or otherwise, and it would be operably connected to the at least one solvent absorption unit 8 by a lean solvent interface 10.

Lean solvent 6 and the sour natural gas stream 7 are the two product inputs to the at least one solvent absorption unit 8 which conducts the step of absorption of one or more selected acid gas fractions from the sour gas stream 7 into the lean solvent 6, yielding rich solvent 9 containing the selected acid gas fractions in a benign and transportable liquid form. Rich solvent 9 would be discharged from the at least one solvent absorption unit 8 by a rich solvent discharge 12, which could again be a connection to a tank, directly to a transport vessels such as the trailer or a train car, or to a pipeline in a local or longer distance application of the system and method of the present invention.

Finally shown in FIG. 2 is the sweetened gas discharge 25. Following absorption of the selected acid gas fractions from the natural gas stream 7, the remaining gas stream would be sweetened natural gas 24 which could simply be piped, stored or otherwise transported or processed in accordance with conventional handling practices.

As outlined elsewhere above, the specifics of the solvent absorption unit or units 8 will be dependent upon the lean solvent 6 which is selected for use in the absorption of whatever the selected acid gas fraction or fractions might be. Dependent upon the solvent selection and the acid gas fractions in question, different types of solvent absorption equipment or techniques could be practiced and any equipment which will accomplish the objective of absorbing the selected acid gas fractions from the natural gas stream 7, via the natural gas stream interface 11, into the lean solvent 6 via its interface with the remainder of the unit 10, to yield a rich solvent 9 and a sweetened natural gas 24 could be used.

The wellsite capture apparatus, as outlined, could either be portable and/or containerized so that it could be moved between wellsites or natural gas source locations, or it could be a permanent installation.

Once the one or more acid gas fractions have been absorbed into the solvent at the wellsite, yielding a rich solvent, the rich solvent is transported to a central plant at a remote treatment site where the acid gas fractions can be removed from the solvent for further processing or disposal. The primary benefit to recovery of the acid fractions at a central plant location is that rich solvent for more than one wellsite location can be processed in a single central plant location, substantially reducing the infrastructure investment which is required to properly handle the recovery of these acid gas fractions in a drilling field or in respect of a drilling field insofar as the solvent would be benign and transportable, various methods of transport or movement of the rich solvent can be contemplated, including by truck, train, pipeline or otherwise. The specific mode of transport of the rich solvent from the wellsite location to the central plant location will be understood to encompass all of these varying types of transportation.

The next step in the method, following the transport of rich solvent from one or more wellsite capture locations to a central plant location, is the recovery of the absorbed acid gas fractions from the rich solvent. The acid recovery step would be conducted at a central plant location, being a location different from the wellsite capture location where the at least one desired acid gas fraction has been absorbed into the lean solvent 6, to create the benign transportable rich solvent 9.

The acid recovery step as would be conducted at the central plant location would comprise the conduct of whatever predetermined set of acid recovery steps or process parameters were required to be conducted or applied to the rich solvent to recover the absorbed acid gas fractions therefrom. The specifics of the acid recovery process would be dependent upon the choice of the lean solvent as well as the acid gas fractions sequestered therein, since depending upon what was required to desorb the acid gas fractions from the solvent those would be the steps, parameters or equipment required to accomplish this process step.

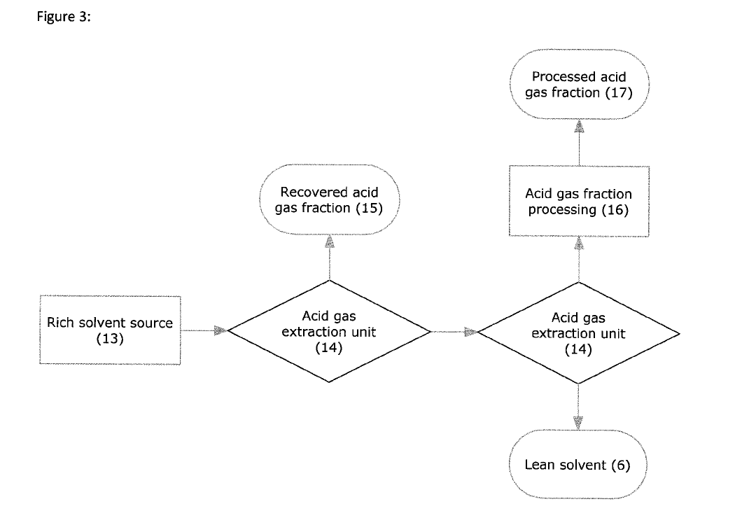

The acid recovery step of this process of the present invention could be conducted using an acid recovery apparatus at the central plant location. One embodiment of the general schematic of acid recovery apparatus is shown in FIG. 3.

The first element of the acid recovery apparatus 27 is a connection or interface 19 with a source of rich solvent 9. The rich solvent 9 would be the solvent which had absorbed the at least one selected acid gas fraction at one or more wellsite capture locations, and the rich solvent interface 19 of the acid recovery apparatus 27 might either comprise a connection to a storage tank or storage vessel where trucks or other transport vessels had been used to deposit the rich solvent 9, or might also comprise, depending upon the configuration of the remainder of the system, a pipeline connection to a pipeline carrying the rich solvent 9 or even a direct connection to a truck trailer etc. a loading facility whereby trailers or train cars etc. could be attached temporarily for the sake of unloading and then removed and used to go and transport more rich solvent 9, perhaps also with a load of lean solvent 6 being conveyed back to the wellsite.

In addition to the rich solvent interface 19, the acid recovery apparatus 27 would comprise at least one acid extraction unit 14. The acid extraction unit 14 would comprise whatever equipment was necessary to effect the removal or recovery of at least one of the absorbed acid gas fractions from the rich solvent 9. In this particular case, two acid extraction units 14 are shown, to demonstrate the concept of the capture and/or removal of more than one acid gas fraction, by the conduct of more than one acid extraction step. Specifically, there is shown a first acid extraction unit 14 which would comprise whatever equipment or process was necessary to recover a first recovered acid gas fraction 15. The first recovered acid gas fraction 15 is in this case shown as well as a first recovered acid gas fraction discharge interface 20 which would basically be an interface to a storage tank or other apparatus into which the recovered acid gas fraction 15 would be conveyed. In this particular case there is then also shown a second acid extraction unit 14 which is intended to demonstrate the recovery of at least two acid gas fractions using this acid recovery apparatus 27. There is shown connected to the second acid extraction unit 14 a lean solvent discharge interface 21, as well as the lean solvent 6 being shown-as outlined elsewhere herein it is contemplated that at the conclusion of the acid recovery step the original lean solvent 6 would be fairly clean if not purified of the presence of any residual acid gas fraction there from and could be reused at wellsite in the practice of the method of the present invention. Also shown in respect of that second acid extraction unit 14 is a second acid gas fraction discharge interface 22. For the sake of demonstration of additional equipment which could optionally be included in the acid recovery unit 27, there is also shown an additional acid gas fraction processing step 16. Additional acid gas fraction processing equipment 16 could actually be a part of the acid recovery in the 27 or else the acid gas fraction discharge interface 22 could simply be connected to additional but separately containerized or separately mounted acid gas fraction processing equipment 16. In any event, following the acid gas fraction processing step and equipment shown at 16, there is shown a processed acid gas fraction 17 and a discharge 23.

As mentioned above, the acid recovery equipment which would be used in accordance with the method could be containerized or manufactured in such a way that it could be moved between locations, so that either is fed by local pipelines or even if so as to allow for relatively short haul local transport of rich solvent from the wellsite to the central plant location, the acid recovery equipment of the present invention could be manufactured in a portable fashion, or in a permanent installation.

One of the key elements of the method is that the recovery and downstream processing of the acid gas fractions from the rich solvent will take place at a central plant location, different from the wellsite. By development of a method for the recovery of acid gas fractions from a sour wellsite gas source which allows for the aggregation of certain portions of the process, equipment costs are minimized and in the system and method of the present invention the absorption of the desired acid gas fractions into a benign transportable liquid solvent also has environmental and safety benefits.

As outlined elsewhere herein the central plant location which could be used in accordance with the method of the present invention could either be in fairly close proximity to one or more wellsite locations, where for example that was desired to use a containerized or portable acid recovery apparatus which was connected by low cost local pipelines to a plurality of acid absorption locations, or it may be the case that it was desired to aggregate the rich solvent 9 from a larger number of natural gas stream originating points and transported longer distances to a larger central plant location.

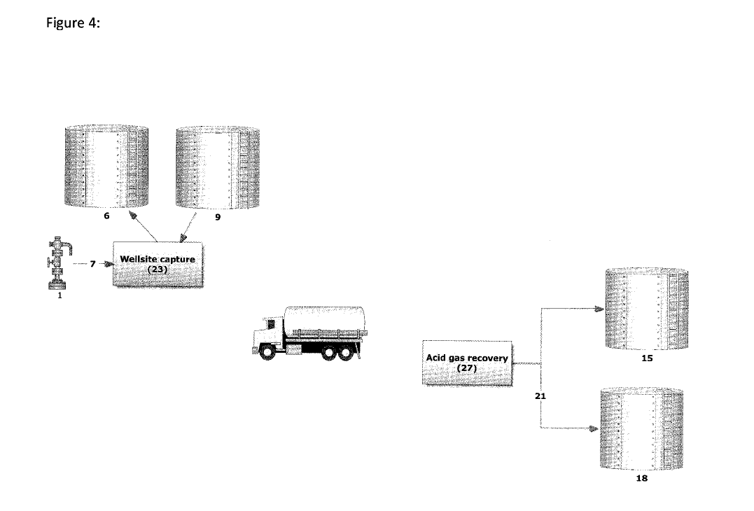

FIG. 4 demonstrates a first hardware configuration of a system in one aspect of the present invention. The system comprises at least one wellsite capture unit 23 and at least one acid recovery unit 27 at a central plant location. In this particular case there is shown a wellsite 1 to which the wellsite capture apparatus 23 is connected via a natural gas stream interface 7. The details of the wellsite capture equipment 23 are discussed elsewhere herein. Shown in this particular figure is a tank for the storage on-site of lean solvent 6 as well as another tank for the capture and storage of the rich solvent containing absorbed acid gas fractions 9. In this particular case the interface or mode of movement to the rich solvent 9 between the wellsite capture apparatus 23 in the central plant location and apparatus 27 is a truck. It will be understood that in an embodiment such as this the infrastructure costs are minimized as no pipeline is used between the wellsite capture 23 in the central plant location 27. Multiple wellsite capture locations 23 could be transported to a single central plant location 27 for desorption. As well, presumably lean solvent which was recovered at the central plant location 27 could be transported back from the central plant location 27 to the wellsite 14 use again by the wellsite capture 23.

In one aspect, a network of temporary pipelines, could be created on a local drilling field basis, which could be manufactured of relatively inexpensive material since it would not need to be noncorrosive, which would feed to a locally installed temporary central plant location. For example the absorption equipment to be used at the wellsite would likely be containerized in some way so that it could be moved between different locations, and it could similarly be the case that the acid recovery equipment could also be containerized but configured in such a way that for example one set of acid recovery equipment on a skid could be used to process rich solvent from a plurality of central plant locations.

In the embodiment of the network of the present invention where the central plant location was connected by relatively low cost pipeline to the well heads, in addition to piping the rich solvent 9 to the central plant location it would also be possible to pipe the lean solvent 6 once the absorbed acid gas fractions were removed therefrom back to the wellsite locations for reuse.

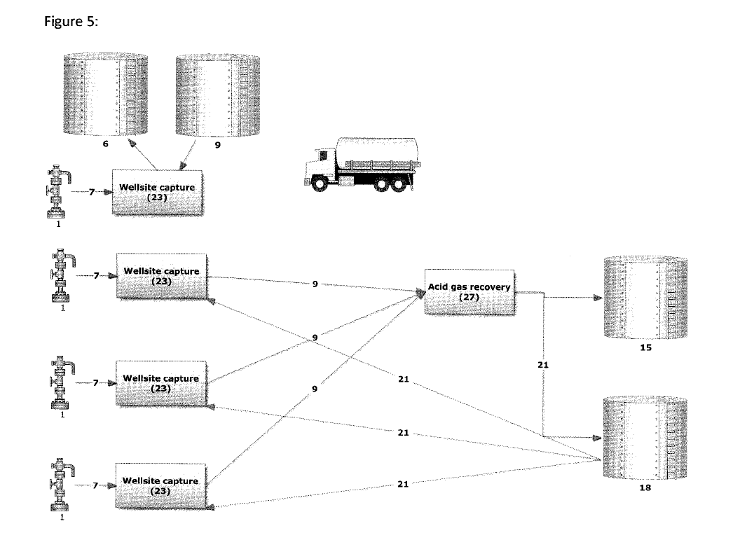

FIG. 5 demonstrates one embodiment of this type of a local acid recovery network, comprising at least one wellsite capture device 23 capable of absorbing at least one acid gas fraction into a lean solvent 6, yielding a rich solvent 9, which can be transported to a central plant location and unit 27 for liberation of the acid gas fractions therefrom. The central plant location 27 would in turn contain the necessary equipment to desorb or remove the absorbed acid gas fractions from the rich solvent 9, yielding at least one recovered acid gas fraction 15, and lean solvent 6 which could be reused. In the embodiment of FIG. 5 there are shown four wellsites 1, three of which are connected by way of pipeline from their respective wellsite capture unit 23 to the acid recovery device 27. The fourth wellsite 1 and related wellsite capture apparatus 23 is shown with a truck representing the ability to in this type of a network configuration encompass various modes of transport of rich solvent.

Also shown in FIG. 5 is a plurality of pipelines from the central plant location back to the wellsite locations 21, which represent the piping back of cleaned lean solvent to the wellsite recovery apparatus too be reused.

One of the key benefits to the method of the present invention is that upon extraction or desorption of the acid gas fractions from the rich solvent at the central plant location, the lean solvent can be reused to absorb an acid gas fraction at the wellsite by transporting it back to a wellsite or gas source location. The ability to recycle solvent will have a great economic benefit but will also result in significant environmental improvements since there will be no solvent discharge, or at the very least very little or minimal solvent discharge, in comparison to a method where the solvent would be disposed.

It will also be understood that upon removal of the absorbed acid gas fractions from the rich solvent 9, the recovered lean solvent 6 could also be stored or repurposed for other use. The only limitation on the ability to reuse the lean solvent 6 for purposes other than reuse in the method would be the level of purification which was achieved at the central plant location but it is believed that a clean lean solvent 6 can be yielded. Slight impurities in the lean solvent 6, being inclusions of small amounts of residual acid gas fractions, would not be problematic in terms of the reuse of the solvent in the method, since the lean solvent 6 would effectively just be transported back to a wellsite location for use.

By choosing the correct lean solvent solution 6 for use in accordance with the remainder of the system and method, more than one acid gas fraction might be recovered from the natural gas stream 7. The solvent could consist of a plurality of chemical agents designed to provide beneficial absorption characteristics for the selected acid gas fractions under field operation parameters. There exist solvents 6 which could individually take up more than one acid gas fraction from the natural gas stream, perhaps based upon the application of different absorption techniques to accomplish the absorption of each such selected acid gas fraction into the lean solvent 6. For example, in the case of hydrogen sulphide and carbon dioxide, solvents exist which could absorb both of these acid gas fractions for the benign transport of the rich solvent containing both products, and that these individual acid gas fractions could then also be desorbed or removed from the rich solvent at the central plant location.

It will be understood that those skilled in the art will be able to conceive of particular combinations of lean solvent materials 6 and solvent absorption units 8 and absorption parameters or processes which will result in the ability to absorb more than one acid gas fraction into a single lean solvent 6 yielding a rich solvent containing more than one acid gas fraction which can in turn be individually removed at the central plant location and all such changes are again contemplated within the scope of the present invention.

It is further contemplated that the method of the present invention might be altered to allow for the combination of local gas fraction capture or segregation from the natural gas stream of certain acid gas fractions, while the solvent absorption and remote recovery of certain other acid gas fractions might still be conducted in accordance with the remainder of the method described herein. The carbon dioxide could be segregated in the hydrocarbon application, the carbon dioxide being one acid gas fraction, while hydrogen sulphide or other acid gas fractions could still be absorbed into a solvent for transport and remote removal. In a case such as this it is believed that body modification of the solvent absorption unit 8 to add whatever other necessary equipment was required, and perhaps by adjusting the selection of lean solvent 6 which was used, it would be possible to recover some acid gas fractions simply at the wellsite which do not require significant infrastructure or hardware investment [such as in the right embodiment the recovery of carbon dioxide for local storage, segregation, sequestration or resale] while still providing for the remote recovery of other acid gas fractions which are more difficult to handle or require more extensive equipment etc.

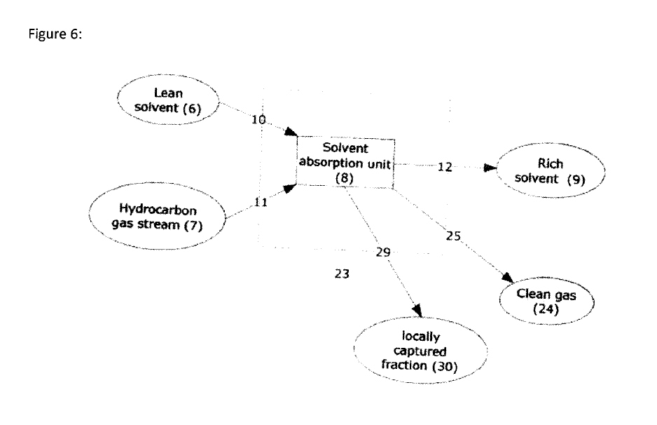

FIG. 6 is provided to demonstrate an alternate schematic for a wellsite capture unit 23 which shows a locally captured fraction 30 and a local capture fraction interface 29. By selecting an appropriate lean solvent six and making appropriate revisions to the wellsite capture unit 23 it would be possible to capture and segregate at the wellsite carbon dioxide for example as a target acid gas fraction, while other acid gas fractions such as hydrogen sulphide etc. were absorbed into the lean solvent 6 for inert transport and subsequent desorption or liberation from the solvent at a central plant location.

The necessary equipment modifications which would be required to the wellsite capture equipment 23 to allow for this type of a hybrid local and remote acid recovery method will be understood by one skilled in the art.

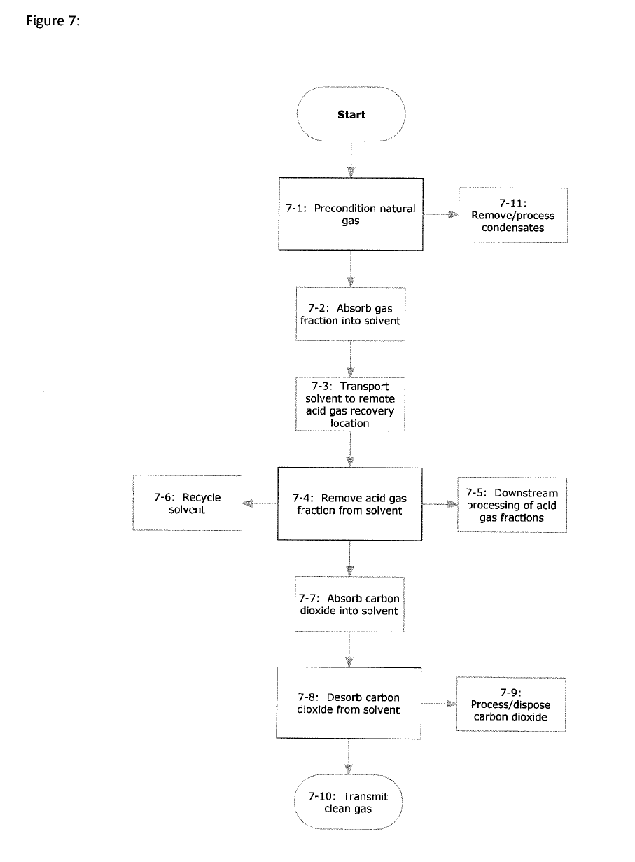

Referring to FIG. 7 there is shown a schematic of one embodiment a method which incorporates a local capture step for the local segregation of one acid gas fraction and the absorption of another acid gas fraction or fractions into a solvent for remote recovery. This method could be used at the location of the well site to separate carbon dioxide, being one acid gas fraction, from the sour natural gas and following the absorption of that carbon dioxide on-site to simply desorbed it again right away for release or for sequestration.

The first number of steps shown in FIG. 7 are similar to those of the method of FIG. 1. The first step in the process is the preconditioning of the sour natural gas stream, to remove condensates there from. The preconditioning step, and the removal of the condensates from the natural gas and for further processing, sale or otherwise is shown at steps 7-1 and 7-11. Following the preconditioning of the natural gas stream there would again be an absorption step in the process, shown at 7-2, in which it is contemplated that one or more acid gas fractions which were desired to be remotely processed and removed would be absorbed into a solvent, yielding a rich solvent. The rich solvent would then be transported at 7-3, to a remote central plant location at which the acid gas fractions would be desorbed from the rich solvent to yield acid gas fractions in a purified state and lean solvent for recycling. The lean solvent could be reused back at the well site to absorb carbon dioxide, being another acid gas fraction which would be desorbed on site so that it could be processed or disposed of on site without the need for transport. It could be the case that the same solvent could be used or designed which would absorb both the other acid gas fractions desired to be liberated from the natural gas as well as the carbon dioxide, or it will also be understood that different solvent could be used.

The preferable embodiment here is that the same solvent will be designed to be used in the absorption or removal of all of the desired acid gas fractions including hydrogen sulfide, carbon dioxide or optionally any other acid gas fractions with the necessary adjustments to the process parameters to activate or enhance the behavior of that solvent package with respect to the particular acid gas fractions in question. Shown and then finally in this Figure is the transmission of clean natural gas, which again may also include traditional or conventional moisture treatment steps etc.

Where the acid gas fraction which was absorbed from the sour natural gas for remote recovery was hydrogen sulfide, the next process step which can be added at the central plant location is the processing of that hydrogen sulfide gas into sulphuric acid.

In addition to the product sulphuric acid processed or manufactured from hydrogen sulfide recovered from sour natural gas, agricultural fertilizer containing sulfur could be manufactured from the obtained sulphuric acid. Following production of sulphuric acid from the hydrogen sulfide which is relatively pure and which is recovered from the rich solvent at the plant location, the sulphuric acid could be used to produce agricultural fertilizer. The sulphuric acid could be manufactured at the plant location or could also be manufactured following transporter transmission of the hydrogen sulfide gas although safety would be enhanced or maximized by on-site or combined location manufacture of the sulphuric acid in addition with the extraction of the hydrogen sulfide from the rich solvent. Various types of fertilizers are contemplated including ammoniated or phosphate fertilizers.

The foregoing is considered as illustrative only of the principles of the invention. Further, since numerous changes and modifications will readily occur to those skilled in the art, it is not desired to limit the invention to the exact construction and operation shown and described, and accordingly, all such suitable changes or modifications in structure or operation which may be resorted to are intended to fall within the scope of the claimed invention.

1. A method for acid recovery from natural gas obtained at a wellsite, the method comprising:
absorbing at the wellsite at least one acid gas fraction from the natural gas into a solvent to form a sweetened natural gas and a rich solvent containing the at least one acid gas fraction and;
transporting the rich solvent to a remote treatment site; and
desorbing at the remote treatment site the at least one acid gas fraction from the rich solvent resulting in an acid gas and a lean solvent.

2. The method of claim 1 wherein the at least one acid gas comprises hydrogen sulphide.

3. The method of claim 1 wherein the at least one acid gas comprises at least carbon dioxide.

4. The method of claim 1 further comprising transporting the lean solvent created from desorbing the rich solvent back to an other wellsite and using the lean solvent to absorb an other at least one acid gas fraction from natural gas obtained at the other wellsite.

5. The method of claim 1 further comprising further processing the deabsorbed hydrogen sulphide into sulphuric acid.

6. The method of claim 5 wherein the sulphuric acid is use for an agricultural fertilizer.

7. The method of claim 1 wherein the rich solvent is transported to the remote treatment side in a tank.

8. The method of claim 1 wherein the rich solvent is transported to the remote treatment site by pipeline.

9. The method of claim 1 wherein the solvent comprise an amine.

10. The method of claim 1 further comprising preconditioning the natural gas at the wellsite to remove condensates from the natural gas before the at least one acid gas fraction is absorbed into the solvent.

11. The method of claim 1 wherein the condensate comprises water.

12. The method of claim 1 wherein the condensate comprises hydrocarbon.

13. The method of claim 1 wherein the solvent comprise more than one chemical agent.

14. The method of claim 1 wherein the remote treatment site is a central plant.

15. The method of claim 14 wherein the central plant is servicing a number of wellsites.

16. The method of claim 1 wherein the equipment used at the wellsite to absorb the at least one acid gas fraction is portable.

17. The method of claim 1 wherein the sweetened natural case is transported to a location different from the remote treatment site.

18. A method for acid recovery from natural gas obtained at a wellsite, the method comprising:
preconditioning the natural gas at the wellsite to remove condensates from the natural gas, the condensates comprising water;
absorbing at the wellsite at least one selected acid gas fraction, the acid gas fraction comprising at least hydrogen sulphide, from the natural gas into a solvent to form a sweetened natural gas and a rich solvent containing the at least one acid gas fraction;
transporting the rich solvent to a remote treatment site;
transporting the sweetened natural gas to a location other than the remote treatment site;
desorbing at the remote treatment site the at least one acid gas fraction from the rich solvent resulting in an acid gas and a lean solvent; and
transporting the lean solvent, created from desorbing the rich solvent, back to the wellsite and using the lean solvent to absorb an other at least one acid gas fraction from natural gas obtained at the wellsite.
